(19) United States
(12) Patent Application Publication
(10) Pub. No.: US 2017/0154151 A1
(43) Pub. Date: Jun. 1, 2017

(54) METHOD OF IDENTIFICATION OF A RELATIONSHIP BETWEEN BIOLOGICAL ELEMENTS

(71) Applicants: VAIOMER, LABEGE (FR); UNIVERSITE PAUL SABATIER TOULOUSE III, TOULOUSE (FR); Centre national de la recherche scientifique, PARIS (FR)

(72) Inventors: Anne-Claire BRUNET, TOULOUSE (FR); Jean-Michel LOUBES, TOULOUSE (FR); Jean-Marc AZAIS, TOULOUSE (FR); Michael COURTNEY, LYON (FR)

(21) Appl. No.: 15/314,326

(22) PCT Filed: May 15, 2015
(86) PCT No.: PCT/EP2015/060779

§ 371 Date: Nov. 28, 2016

(30) Foreign Application Priority Data
May 28, 2014 (FR) 14 54889

(51) Int. Cl. G06F 19/12; G06F 17/16

(52) U.S. Cl. CPC G06F 19/12; G06F 17/16

(57) ABSTRACT

The present invention relates to a method for identifying a relationship between biological elements, said elements optionally having a measurable activity, the method comprising the following steps:
defining candidate graphs, each candidate graph being a graph associated with one of the thresholding values from the plurality of thresholding values,
for each thresholding value, obtaining a distribution associated by optimization of the distribution into classes of the apices of the graph associated with the relevant thresholding value, the optimization starting with an initial distribution in which with each core is associated a class for obtaining a final distribution in which each apex of a class shares more links with the other apices of the same class than with the apices of another class,
selecting an optimum graph from among the plurality of candidate graphs according to at least one criterion.

The present invention relates to a method for identifying a relationship between physical elements. The invention also relates to a method for identifying a therapeutic target for preventing and/or treating a pathology. The invention also relates to a method for identifying a diagnostic biomarker, a susceptibility biomarker, a prognostic biomarker for a pathology or predictive of a response to a treatment of a pathology. The invention also proposes a method for screening a compound useful as a drug, having an effect on a known therapeutic target, for preventing and/or treating a pathology. The invention also relates to the associated computer program products.

The occurrence of sequencing of proteins in the 1950s and then of DNA in the 1970s, and the development of automatic sequences, has caused a revolution in biology. To the conventional descriptive and reductionist approach (a gene, a messenger RNA, a protein) has succeeded a more global understanding of biological systems based on the analysis of sets of biological elements (‘-omes’) the (‘-omic’) structures of which are studied. The basic idea associated with the ‘omic’ approaches consists of apprehending the complexity of living organisms as a whole, by means of methodologies as less restrictive as possible on the descriptive level.

Such approaches mainly comprise: genomics (study of genes), transcriptomics (analysis of the expression of the genes and its regulation), proteomics (study of proteins), metabolomics (analysis of metabolites).

Genomics is divided into two branches: structural genomics, which deals with the sequencing of the entire genome, and functional genomics, which aims at determining the function and the expression of the sequenced genes. In functional genomics, the techniques are applied to a large number of genes in parallel: for example the phenotype of mutants may thus be analyzed for a whole family of genes, or the expression of all the genes of an entire organism.

Transcriptomics is the study of the whole of the messenger RNAs produced during the transcription process of a genome. It is based on the quantification of the whole of these messenger RNAs, which gives the possibility of having an indication relative to the transcription level of different genes under given conditions.

Proteomics is the analysis of the whole of the proteins of an organite, of a cell, of a tissue, of an organ or of an organism under given conditions. Proteomics is committed to identifying in a global way the proteins extracted from a cell culture, from a tissue or from a biological fluid, their localization in the cell compartments, their optional post-translational modifications, as well as their amount. It allows quantification of the variations of their expression level for example versus time, their environment, their stage of development, their physiological and pathological state, of the original species. It also studies the interactions which the proteins have with other proteins, with DNA or RNA, or other substances.

Metabolomics studies the whole of the metabolites (sugars, amino acids, fatty acids, etc.) present in a cell, an organ, an organism.

The previous approaches give the possibility of obtaining very many pieces of information on the cell and/or tissue response to an exposure in vitro or in vivo. They may in particular be useful for showing and identifying novel biomarkers (for diagnostic, for susceptibility, for prognosis, of exposure, of an effect), generating novel pieces of knowledge on the mechanistic level (modes of action), or further elaborating novel efficiency or predictive toxicological tools for contributing to the identification of novel therapeutic targets or novel candidate drugs.

The automization of the sequencing techniques and the development of techniques with a high throughput, notably made possible by means of the occurrence of specialized technological platforms, has allowed industrialization of the production of the data and simultaneous analysis of a large number of variables.

From this results a very large number of data to be processed, analyzed, viewed and interpreted as most informative as possible in order to extract the maximum of information on the biological process or on the studied biological system.

Therefore it is desirable to have available biostatistical and powerful biocomputer means giving the possibility of processing, analyzing and interpreting the mass of data generated by the ‘omic’ approaches.

From the biostatistical point of view, the data obtained by the ‘omic’ approaches deal with very many variables which should be analyzed together. For example, the transcriptomics analyses give the possibility of simultaneously studying the expression of several thousands of genes. On the other hand, the number of individuals on which these analyses are conducted is limited because of the difficulty of forming cohorts of patients, so that the number of variables generally exceeds the size of the sample. Conventional statistical methods can no longer be used. Analysis of the obtained data then amounts to considering two distinct problems of statistical research, i.e. the calculation of the covariance matrix and the non-supervised classification of the apices of a graph also called partitioning of the graph.

Concerning the first problem, within the context of the large dimension, when the number of variables exceeds the size of the sample, there exist two large families of methods for making a penalized estimation of the covariance matrix. The first family groups methods which benefit from a natural order in the data by assuming that more the variables are away from each other according to this order and more their dependency is low. The second family of methods groups methods for estimating the covariance insensitive to the order of presentation of the data. This is the case of methods which consist of adding a penalty I1 to the likelihood maximization problem in the Gaussian case or thresholding methods on the empirical covariance matrix.

However, both families of methods are inefficient when the sample is of a too small size. Indeed, both families of methods involve setting a regularization parameter so as to obtain an optimal estimator. Now, there is no analytical way for setting the regularization parameter. Further, the previous methods prove to be costly in computing time when the number of variables is too large.

The second problem relative to the partitioning is posed after the first problem of computing the covariance matrix. In fact, the calculated covariance may be illustrated by a graph and the construction of the graph does not have any particular difficulty. Two apices (variables) are connected on the graph if their covariance is not zero. The second problem is that of the identification of the groups of apices connected on the graph (graph partitioning). For this, many approaches are conceivable. As an example, the spectral methods are based on the definition of a similarity measurement on the space of the apices of the graph from eigenvectors of the Laplacian of the graph which is used for partitioning the graph with an algorithm of the k-means type (often designated as ‘k-means’) for example.

However, all these methods are costly in terms of time and more often impose the setting a priori of the number of classes, which limits the quality of the obtained partitionings.

Therefore there exists a need for a method for identifying a relationship between physical elements giving the possibility of surmounting the previous drawbacks.

For this purpose, a method for identifying a relationship between physical elements is proposed, said elements optionally having a measurable activity, the method comprising the step for providing data, the data comprising a representative quantity of the physical elements or of their activity for a plurality of individuals, the step of estimating the covariance matrix between the different quantities representative of the physical elements or of their activity from the provided data, the step for associating a graph with a thresholding value, the associated graph comprising representative apices of the physical elements and of links between the apices when the value of the covariance between the relevant apices is greater than the relevant thresholding value. The method also includes the step for obtaining cores by analyzing the time-dependent change of the graphs by using a plurality of thresholding values, a core being a set of apices of a graph such that the number of apices is greater than or equal to a set number, such that there exists a thresholding value for which the core is a connected component of the graph associated with the thresholding value and such that there do not exist any other connected components of a graph for which the number of apices is greater than or equal to the set number and which is included in the core, the step for defining candidate graphs, each candidate graph being a graph associated with one of the thresholding values of the plurality of threshold values. The method also includes, for each thresholding value of the plurality of thresholding values, a step for obtaining a distribution associated by optimization of the distribution into classes of the apices of the graph associated with the relevant thresholding value, the optimization starting with an initial distribution in which with each core is associated a class for obtaining a final distribution in which each apex of a class shares more links with the other apices of the same class than with the apices of another class. The method also comprises a step for selecting an optimal graph from among the plurality of candidate graphs according to at least one criterion.

The originality of the method for identifying a relationship, as proposed, notably lies in the fact that both problems for calculating the covariance matrix and partitioning the graph are processed together.

Thus, on the one hand, it is suggested to analyze the time-dependent change in the structure of the graph versus a thresholding value and to select the covariance matrix and the associated graph on the basis of criteria dealing with the graph (density, distribution of the degrees . . . ) and on its partitioning (modularity, number of classes, stability of the classes . . . ). On the other hand, the partition of the graph is based on the selection of cores which are a set of apices strongly connected on the graphs, i.e. through links with a great weight (covariance). Consequently, the method for partitioning the graphs takes into account the most reliable portion of the information contained in the covariance matrix.

The method for identifying a relationship is applied to data with a very large dimension (several thousand variables). Further, the number of classes is not set, as well as the value of the thresholding parameter.

According to a preferred embodiment, the identification method gives the possibility of analyzing the time-dependent change in the graphs depending on the selection of the thresholding value in two phases. In a first phase, cores of classes are sought by increasing stepwise the thresholding value so as to gradually ‘trim’ the graph and to identify small sets of stable apices within the different connected components of the graphs. In a second phase, by gradually lowering the thresholding value, the apices of the graph are gradually reconnected so as to be able to assign to them a class defined around a core.

The method for identifying a relationship finally gives the possibility of selecting the covariance matrix and the associated graph which has the most clear and most stable interaction structure.

In particular, the method for identifying a relationship may give the possibility of identifying sets of genes having a relationship with each other on the basis of their expression levels in the relevant samples, or having similar expression profiles. Genes for which the expression profiles are similar (co-expressed genes) may for example have identical regulation mechanisms or be part of a same regulation route, i.e. be co-regulated.

The regulation of the expression of a gene designates the set of regulation mechanisms applied during the process for synthesizing a product of a functional gene (RNA or protein) from the genetic information contained in a DNA sequence. The regulation designates a modulation, in particular an increase or a decrease in the amount of the products from the expression of a gene (RNA or protein). All the steps ranging from the DNA sequence to the final product of the expression of a gene may be regulated, whether this is the transcription, the ripening of messenger RNAs, the translation of the messenger RNAs or the stability of the messenger RNAs or of the proteins.

For example, the method for identifying a relationship may give the possibility of identifying a relationship between genes or proteins which are all strongly expressed, or strongly over-expressed relatively to a control, or between genes or proteins which are all not very expressed, or strongly under-expressed relatively to a control.

In a preferred embodiment, the method for identifying a relationship advantageously gives the possibility of organizing the genes, RNAs or proteins, for which the expression profiles are identical, into groups or sets, according to a hierarchical group.

According to a particular embodiment, the method for identifying a relationship advantageously gives the possibility of identifying interactions between genes.

According to another embodiment, the method for identifying a relationship advantageously gives the possibility of identifying sets of genes which are co-expressed and/or co-regulated. This may give the possibility of identifying regulation routes which are not yet known. Moreover, a gene the function of which is unknown and which is part of a set containing a large number of genes involved in a particular cell function or a particular cell process, has a strong likelihood of being also itself involved in this function or in this process. Thus, by starting with the assumption that co-expressed and/or co-regulated genes may be related functionally, the method may give the possibility of identifying the putative function of certain genes.

According to particular embodiments, the method for identifying a relationship between physical elements comprises one or several of the following features, taken individually or according to any technically possible combinations:
in the step for obtaining cores, the values of the plurality of thresholding values are used in an increasing way.
the step for obtaining an associated distribution, the values from the plurality of thresholding values are used in a decreasing way.
the step for estimating the covariance matrix includes a sub-step for computing the empirical covariance matrix, a sub-step for regularization and a sub-step for normalization.
the step for obtaining cores applies an in-depth course algorithm.
the final distribution includes less classes than the number of obtained cores.
the number of physical elements is greater than or equal to 1,000, preferentially greater than or equal to 3,000, still more preferentially greater than or equal to 5,000.
the ratio between the number of physical elements and the number of individuals is greater than or equal to 10, preferentially greater than or equal to 30, still more preferentially greater than or equal to 50.
the method for identifying a relationship being applied by a computer.
the physical elements are genes, RNAs, proteins or metabolites.
the individuals are biological individuals such as animals, preferably mammals, still more preferentially humans.

A method for identifying a therapeutic target is also proposed for preventing and/or treating a pathology, the method comprising the step for applying the method for identifying a relationship as described earlier, the plurality of individuals being a plurality of biological individuals suffering from said pathology and the representative quantity being the quantification of the expression of at least one gene of the plurality of individuals, in order to obtain a first distribution in which each first class is associated in a one-to-one way with a first value of the representative quantity. The method for identifying a therapeutic target also comprises the step for applying the method for identifying a relationship as described earlier, the plurality of individuals being a plurality of biological individuals not suffering from said pathology and the representative quantity being the quantification of the expression of at least one gene of the plurality of individuals, in order to obtain a second distribution in which each second class is associated on a one-to-one basis with a second value of the representative quantity. The method also includes the step for comparing the first distribution and the second distribution, and the step for selecting as a therapeutic target the gene, or a product from the expression of the gene, if the representative apices of said gene belong to a first class and to a second class, for which the first value and the second value significantly differ.

A method for identifying a diagnostic, susceptibility, prognosis biomarker of a pathology or predictive of a response to a treatment of a pathology, is also proposed. The method for identifying a biomarker comprises the step of applying the method for identifying a relationship as described earlier, the plurality of individuals being a plurality of biological individuals suffering from said pathology and the representative quantity being the quantification of the expression of at least one gene of the plurality of individuals, in order to obtain a first distribution in which each first class is associated on a one-to-one basis with a first value of the representative quantity. The method for identifying a biomarker also comprises the step for applying the method for identifying a relationship as defined earlier, the plurality of individuals being a plurality of biological individuals not suffering from said pathology and the representative quantity being the quantification of the expression of at least one gene of the plurality of individuals, in order to obtain a second distribution in which each second class is associated on a one-to-one basis with a second value of the representative quantity. The method for identifying a biomarker also includes the step for comparing the first distribution and the second distribution, and for selecting as a biomarker the gene, or an expression of the gene, if the representative apices of said gene belong to a first class and to a second class for which the first value and the second value significantly differ.

A method for screening a useful compound as a drug is also proposed, having an effect on a known therapeutic target, for preventing and/or treating a pathology, the method comprising the step of applying the method for identifying a relationship as described earlier, the plurality of individuals being a plurality of biological individuals suffering from said pathology and having received said compound, the representative quantity being the quantification of the expression of at least one gene of the plurality of individuals, and the data comprising the representative quantity of the therapeutic target, in order to obtain a first distribution in which each first class is associated on a one-to-one basis with a first value of the representative quantity. The method for screening a compound also includes the step for applying the method for identifying a relationship as described earlier, the plurality of individuals being a plurality of biological individuals suffering from said pathology and not having received said compound, the representative quantity being the quantification of the expression of at least one gene of the plurality of individuals, and the data comprising the representative quantity of the therapeutic target, in order to obtain a second distribution in which each second class is associated on a one-to-one basis with a second value of the representative quantity. The method for screening a compound also comprises the step for comparing the first distribution and the second distribution, and the step for selecting the compound if the representative apices of the known therapeutic target belong to a first class and to a second class for which the first value and the second value significantly differ.

A computer program product is also proposed including a readable information medium, on which a computer program is stored in memory comprising program instructions, the computer program being loadable on a data processing unit and adapted for causing the application of a method as described earlier when the computer program is applied on the data processing unit.

Other features and advantages of the invention will become apparent upon reading the description which follows of embodiments of the invention, only given as an example and with reference to the drawings which are:

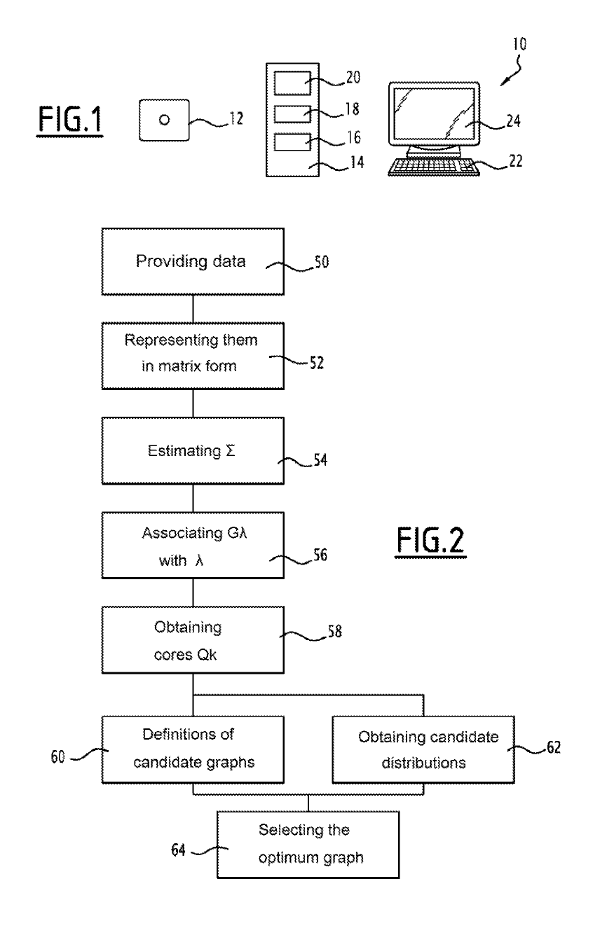

FIG. 1 is a schematic view of an example of a system allowing the application of a method for identifying a relationship between physical elements,

FIG. 2 is a flowchart of an example for applying a method for identifying a relationship between physical elements,

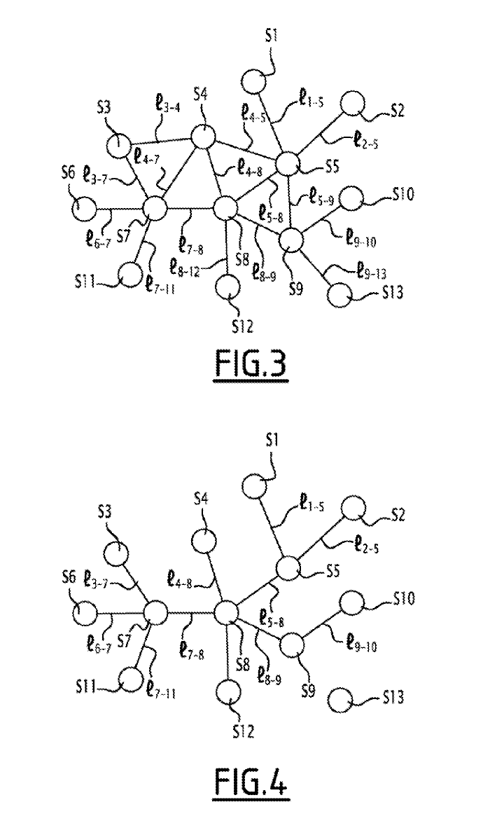

FIGS. 3 to 6, are schematic views of a plurality of graphs for different thresholding values,

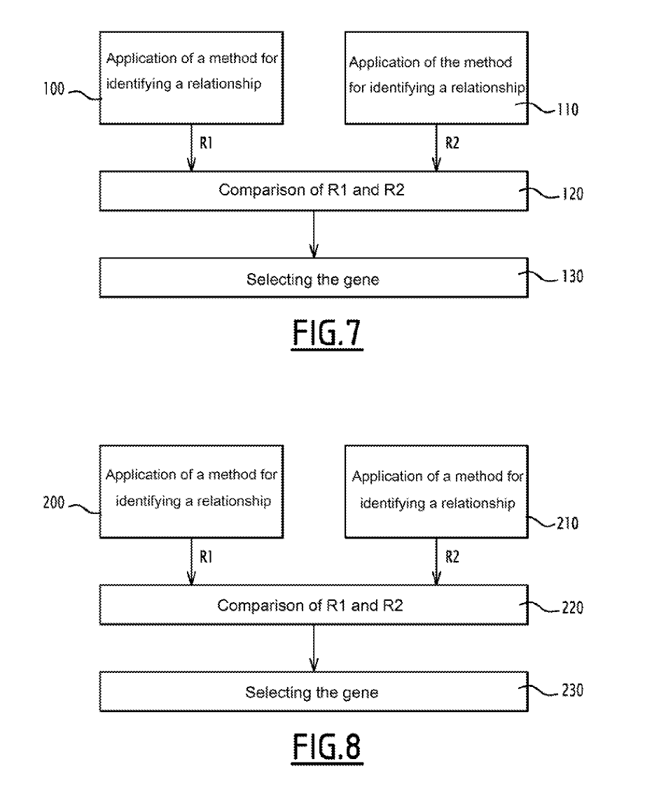

FIG. 7 is a flowchart of an example for applying a method for identifying a therapeutic target for preventing and/or treating a pathology,

FIG. 8 is a flowchart of an example for applying a method for identifying a diagnostic, susceptibility, prognostic biomarker of a pathology or predictive of a response to a treatment of a pathology, and

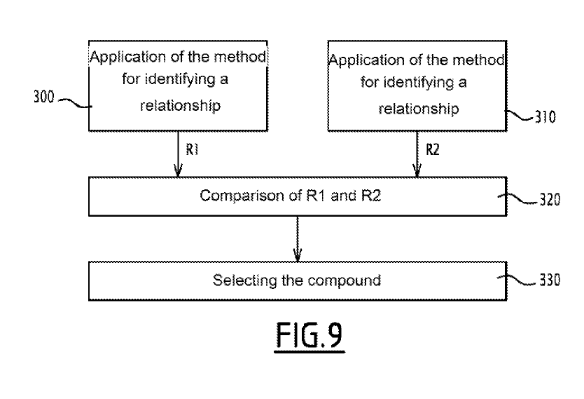

FIG. 9 is a flowchart of an example for applying a method for screening a compound, useful as a drug, having an effect on a known therapeutic target, for preventing and/or treating a pathology.

A system 10 and a computer program product 12 are illustrated in FIG. 1. The interaction of the computer program product 12 with the system 10 allows application of a method for identifying a relationship between physical elements.

The system 10 is a computer.

More generally, the system 10 is an electronic computer able to handle and/or transform data represented as electronic or physical quantities in registers of the system 10 and/or as memories in other similar data corresponding to physical data in memories, registers or other types of display, transmission or memory-storage devices.

The system 10 includes a processor 14 comprising a data processing unit 16, memories 18 and an information medium reader 20. The system 10 also comprises a keyboard 22 and a display unit 24.

The computer program product 12 includes a readable information medium 20.

A readable information medium 20 is a medium readable by the system 10, usually through the data processing unit 14. The readable information medium 20 is a medium adapted for storing in memory electronic instructions and capable of being coupled with a bus of a computer system.

As an example, the readable information medium 20 is a diskette or floppy disk, an optical disk, a CD-ROM, a magneto-optical disk, a ROM memory, a RAM memory, an EPROM memory, an EEPROM memory, a magnetic card or an optical card.

On the readable information medium 20 is stored in memory a computer program comprising program instructions.

The computer program is loadable on the data processing unit 14 and is adapted for causing the application of a method for identifying a relationship between physical elements when the computer program is applied on the data processing unit 14.

The operation of the system 10 in interaction with the computer program product 12 is now described with reference to FIG. 2 which illustrates an example for applying a method for identifying a relationship between physical elements.

An element is a physical element when the element belongs to reality.

For example, atoms are physical elements. The statistical study of the spin states of a set of atoms is of interest both for spintronics and for material condensation problems.

According to another example, stars are physical elements. The emitted amount of a particular particle for different stars may notably be compared.

According to another example, the particles emitted by a star are physical elements. The study of particles emitted by a star gives the possibility of determining a piece of information on the state of the star considered statistically.

In the remainder of the description, examples of physical elements belonging to the field of biology are more specifically considered, without these examples being a limitation of the present method.

Notably, according to a preferred embodiment, the physical elements are biological elements. For example, the physical elements may be genes, RNAs, in particular Messenger RNAs, proteins or metabolites.

The method for identifying a relationship is all the more advantageous since the number of relevant physical elements is significant so that the physical elements are preferably sets of large dimensions.

For example, the number of physical elements is greater than or equal to 1000, preferably greater than or equal to 2000, preferably greater than or equal to 3000, preferably greater than or equal to 4000, preferably greater than or equal to 5000, preferably greater than or equal to 6000, preferably greater than or equal to 7000, preferably greater than or equal to 8000, preferably greater than or equal to 9000, preferably greater than or equal to 10000.

By the term of relationship is meant a link or a connection existing between two elements.

The method for identifying a relationship includes a step 50 for providing data relative to a plurality of individuals. The data for a particular individual comprise a quantity representative of each of the physical elements.

As a particular example, the representative quantity of a physical element may be the amount of the physical element. For example, the representative quantity of a protein in a given sample may be the amount of this protein in this sample. Thus, in such a particular case, as an illustration, a first protein will have a weight of 15 kiloDaltons, a second protein would have a weight of 10 kiloDaltons, a third protein would have a weight of 12 kiloDaltons.

Through the proposed particular example, it appears that by representative quantity of a physical element, is meant any type of measurable quantity which characterize the physical element. A representative quantity of a physical element may therefore be expressed as an amount.

According to a particular embodiment, the relevant quantity is representative of the activity of a physical element.

In particular, for the previous example of the atom, the spin is a representative quantity.

According to another example, for the case when the particles emitted by a star are the physical elements, the amount of emitted particles is a representative quantity. Similarly, for the example of stars, the amount of the emitted particular particle by each of the stars is a representative quantity.

The activity of a physical element represents the whole of the effects produced by the relevant physical element. Notably, when the physical element is a gene, the activity of the physical element may refer to the expression of said gene. The expression of a gene may in particular be quantified by measuring the amount of messenger RNA produced by the transcription process from said gene, or by measuring the amount of protein produced by the transcription and translation processes from said gene.

The representative quantity of the activity of a physical element may be the amount of a product resulting from the activity of the physical element. For example, the representative quantity of the activity of a gene may be the amount of messenger RNAs produced by the transcription process from said gene. According to another example, the representative quantity of the activity of a messenger RNA may be the amount of proteins produced by the translation process from said messenger RNA.

By the term of individual is meant a statistical element of a wider set called a <<population>>, and for which the value of the representative quantity of each of the physical elements, or of their activity, is provided in the provision step 50.

In the case of the example of atoms, the plurality of individuals is a plurality of atoms.

For the example of particles emitted by a same star, the plurality of individuals may be emissions at distinct time instants.

For the case when a plurality of stars is considered, the plurality of individuals is preferably the plurality of stars.

According to a particular embodiment, the individual may be a biological individual such as for example an animal. Preferably, the individual is a mammal. Still more preferentially, the individual is a human.

The method for identifying a relationship is all the more advantageous since the ratio between the number of physical elements and the number of individuals is greater than or equal to 10, preferably greater than or equal to 20, preferably greater than or equal to 30, preferably greater than or equal to 40, preferably greater than or equal to 50, preferably greater than or equal to 60, preferably greater than or equal to 70, preferably greater than or equal to 80, preferably greater than or equal to 90, preferably greater than or equal to 100, preferably greater than or equal to 200.

Alternatively or additionally, the number of individuals may be less than or equal to 200, preferably less than or equal to 100.

The data thus comprise, for a plurality of individuals, the different values of a representative quantity selected for each physical element. As explained earlier, according to a particular embodiment, the number of provided representative quantities is greater than or equal to 1000 for each relevant individual.

The data provided in the provision step 50 may be obtained by any means. In particular, the data may be obtained by an analysis of the omic type, for example by a genomic, transcriptomic, proteomic, or metabolomic analysis. The techniques giving the possibility of obtaining data of the ‘omic’ type are well known to one skilled in the art and for example comprise those of DNA chips, of quantitative PCR or of systematic sequencing of DNA, RNA or complementary DNA.

In a particular embodiment, the data provided in the provision step 50 are obtained from a biological sample of the individual, such as one or several organs, tissues, cells or cell fragments of the individual.

At the end of the provision step 50, data comprising a representative quantity of the physical elements for a plurality of individuals have been provided.

From a mathematical point of view, the provided data correspond to the case of n models (n individuals) of p random variables X₁, . . . , Xₚ (p representative quantities). In this context, n and p are two integers.

For the following, in a sake of simplifying the matter, as an illustration, it is assumed that the random variables X₁, . . . , Xₚ are centered.

The method includes a step 52 for representing the data provided in matrix form in order to obtain a data matrix noted as X, for which the element of line i and of column j is the value of the i-th representative quantity Xᵢ for the j-th model.

The method includes a step 54 for estimating the covariance matrix Σ between the different representative quantities from the data matrix.

In probability and statistical theory, the variance-covariance matrix or more simply the covariance matrix of a series of p real random variables X₁, . . . , Xₚ is the square matrix for which the element of line i and of column j is the covariance of the variables Xᵢ and Xⱼ. Such a matrix gives the possibility of quantifying the variation of each variable relatively to each of the other ones.

According to an embodiment, the estimation step 54 includes a computation sub-step.

As an example, in the computation sub-step, the empirical covariance matrix S is computed. By definition, S is the product of the reciprocal of the integer n by the matrix product of the data matrix X by the transposed data matrix X. This is written mathematically as:

$$S = \frac{1}{n} \cdot X * {X}^{t}$$

wherein:
<<·>> refers to the mathematical operation of multiplication by a scalar,
<<*>> refers to the mathematical matrix multiplication operation, and
X^{t} designates the transposed data matrix X.

According to another example, in the computation sub-step, the correlation matrix of Spearman is computed.

According to another embodiment, the estimation step 54 includes a regularization sub-step.

The regularization sub-step gives the possibility of forcing values of the covariance matrix to be zero in order to obtain a hollow matrix (i.e. a matrix comprising many zeros).

For example, the regularization sub-step is applied to the empirical covariance matrix S computed in the computation sub-step, in order to obtain a regularized covariance matrix S_{regularized}.

According to a particular case, the regularization sub-step is applied by using a thresholding value λ, the thresholding value λ being positive or zero. More specifically, in order to obtain the empirical regularized covariance matrix S_{regularized}, all the values of the empirical covariance matrix S for which the absolute value is strictly less than the thresholding value λ are set to 0.

As the thresholding value λ is a variable, the regularized empirical covariance matrix S_{regularized} is a function of the thresholding value λ. Notably, when the thresholding value λ is zero, the regularized empirical covariance matrix S_{regularized} is the empirical covariance matrix S. On the contrary, when the thresholding value λ tends to infinity, the regularized empirical covariance matrix S_{regularized} tends towards the zero matrix, i.e. a matrix for which all the terms are zero.

Such a regularization sub-step is particularly advantageous when the integer p is large or when the integer p is greater than the integer n. Indeed, in such cases, the regularized empirical covariance matrix S_{regularized} is an estimator of better quality than the empirical covariance matrix S, the function of the thresholding value λ giving the possibility of removing too small non-significant values. This notably stems from the fact that there may exist noise in the provided data and that there exist a risk of existing one or several positive false values.

Optionally, the estimation step 54 also includes a normalization sub-step in order to obtain a normalized matrix.

For example, the normalization sub-step is applied to the empirical covariance matrix S.

According to a preferred embodiment, the normalization sub-step is applied by computing the following matrix product:

$$R = {D}_{\frac{1}{σ}} * S * {D}_{\frac{1}{σ}}$$

wherein:
R refers to the normalized matrix, and

$${D}_{\frac{1}{σ}}$$

refers to the diagonal matrix of the standard-deviations. By definition, the diagonal matrix of the standard-deviations

$${D}_{\frac{1}{σ}}$$

is a diagonal matrix for which the i-th term of the diagonal is equal to the reciprocal of the standard-deviation of the i-th variable Xᵢ, i being an integer varying between 1 and the integer p.

In statistics, the correlation of two variables A and B is equal to the ratio between the covariance between said two variables A and B on the one hand and, the standard-deviation product of the first variable A by the standard-deviation of the second variable B on the other hand. The result of this is that the normalized matrix R corresponds to the matrix of the empirical correlations.

According to these cases, the estimation step 54 thus includes a computation sub-step, or the combination of a computation sub-step and of a regularization sub-step or the combination of a computation sub-step and a normalization sub-step or a combination of the computation, regularization and normalization sub-steps.

In the case when the three sub-steps are applied, the order for applying regularization and normalization sub-steps is irrelevant. Further a regularized matrix of empirical correlations R_{regularized} is obtained and the thresholding value is comprised between 0 and 1. In the following description, a value Y is comprised between two values a and b when, on the one hand, the value Y is greater than or equal to the value a and, on the other hand, the value Y is less than or equal to the value b.

Like for the case of the regularized empirical covariance matrix S_{regularized}, as the thresholding value λ is a variable, the regularized matrix of empirical correlations R_{regularized} is a function of the thresholding value λ. Notably, when the thresholding value λ has the value 0, the regularized matrix of empirical correlations R_{regularized} is equal to the matrix of empirical correlations R. On the contrary, when the thresholding value λ has the value 1, the regularized matrix of empirical correlations R_{regularized} tends to the zero matrix, i.e. a matrix for which all the terms are zero.

At the end of the estimation step 54, an estimated covariance matrix \hat{Σ} is obtained grouping the estimated covariance values between the different representative quantities of the physical elements or of their activity. Alternatively, a Spearman correlation matrix is obtained when the dependency among the variables is non-linear.

As an example, for the following, it is assumed that the estimated covariance matrix \hat{Σ} is the regularized matrix of the empirical correlations R_{regularized}, i.e. that \hat{Σ}=R_{regularized}.

The method for identifying a relationship also includes a step 56 for associating a graph G_{λ} with a thresholding value λ.

By definition, a graph G_{λ} is associated with a thresholding value λ when the graph G_{λ} comprises representative apices of the physical elements, and links between the apices when the estimated value of the covariance between the relevant apices is greater than or equal to the relevant thresholding value λ.

A graph G_{λ} is a graphic representation of the estimated value of the covariance relatively to a given thresholding value λ. This means that the only links visible on a graph G_{λ} are links having a relatively large value of the estimated covariance.

In the particular case of FIG. 2, the graph G_{λ} includes links between the apices when the value of the regularized matrix of the empirical correlations R_{regularized} relative to the relevant apices is greater than or equal to the relevant thresholding value λ.

Thus, when the thresholding value λ has the value 0, the graph G₀ is a graph for which all the apices are connected to all the other apices. On the contrary, when the thresholding value λ has the value 1, the graph G₁ is a graph for which all the apices are isolated, i.e. there is no link between the apices.

More specifically, it appears that the function which associates with the thresholding value λ the number of links to be generated in the graph G_{λ} associated with the thresholding value λ is a decreasing function from the value of the number of links in the graph G₀ down to 0.

As an illustration, FIGS. 3 to 6 each illustrate graphs associated with different thresholding values for a particular example.

FIG. 3 illustrates a first graph G_{λ1} associated with a first thresholding value λ₁. The first graph G_{λ1} includes the same thirteen apices, each apex being represented by a point on the figure. Further, each apex is referenced with a reference sign in the form of Si wherein i is the number of the apex. For example, the second apex is referenced as S2 and the seventh apex is referenced as S7.

In the first graph G_{λ1}, there exist sixteen links between the thirteen apices S1 to S13. Thus, the first apex S1 is connected to the fifth apex S5 via a first link l₁₋₅. The second apex S2 is connected to the fifth apex S5 via a second link l₂₋₅. The third apex S3 is connected to the fourth apex S4 via a third link l₃₋₄ and to the seventh apex S7 via a fourth link l₃₋₇. The fourth apex S4 is connected to the third apex S3 via the third link l₃₋₄, to the fifth apex S5 via a fifth link l₄₋₅, to the seventh apex S7 via a sixth link l₄₋₇ and to the eighth apex S8 via a seventh link l₄₋₈. The fifth apex S5 is connected to the fourth apex S4 via the fifth link l₄₋₅, to the eighth apex S8 via an eighth link l₅₋₈ and to the ninth apex S9 via a ninth link l₅₋₉. The sixth apex S6 is connected to the seventh apex S7 via a tenth link l₆₋₇. The seventh apex S7 is connected to the third apex S3 via the fourth link l₃₋₇, to the fourth apex S4 via the third link l₃₋₄, to the eighth apex S8 via an eleventh link l₇₋₈, to the sixth apex S6 via the tenth link l₆₋₇ and to the eleventh apex S11 via a twelfth link l₇₋₁₂. The eighth apex S8 is connected to the fourth apex S4 via the seventh link l₄₋₈, to the fifth apex S5 via the eighth link l₅₋₈, to the seventh apex S7 via the eleventh link l₇₋₈, to the ninth apex S9 via a thirteenth link l₈₋₉ and to the twelfth apex S12 via a fourteenth link l₈₋₁₂. The ninth apex S9 is connected to the fifth apex S5 via the ninth link l₅₋₉, to the eighth apex S8 via the thirteenth link l₅₋₉, to the tenth apex S10 via a fifteenth link l₉₋₁₀ and to the thirteenth apex S13 via a sixteenth link l₉₋₁₆. The tenth apex S10 is connected to the ninth apex S9 via the fifteenth link l₉₋₁₀. The eleventh apex S11 is connected to the seventh apex S7 via the twelfth link l₇₋₁₂. The twelfth apex S12 is connected to the eighth apex S8 via the fourteenth link l₈₋₁₂. The thirteenth apex S13 is connected to the ninth apex S9 via the sixteenth link l₉₋₁₆.

This means that the first link l₁₋₅, the second link l₂₋₅, the third link l₃₋₄, the fourth link l₃₋₇, the fifth link l₄₋₅, the sixth link l₄₋₇, the seventh link l₄₋₅, the eighth link l₅₋₅, the ninth link l₅₋₉, the tenth link l₆₋₇, the eleventh link l₇₋₅, the twelfth link l₇₋₁₂, the thirteenth link l₅₋₉, the fourteenth link l₅₋₁₂, the fifteenth link l₉₋₁₀ and the sixteenth link l₉₋₁₆ each correspond to values of estimated covariance between the relevant apices which are strictly greater than the first thresholding value λ₁.

FIG. 4 illustrates a second graph G_{λ2} associated with a second thresholding value λ₂. As FIG. 4 is similar to FIG. 3, only the differences with FIG. 3 are detailed in the following.

The second thresholding value λ₂ is greater than the first thresholding value λ₁. Further, the second graph G_{λ2} includes no more than eleven links since the third link l₃₋₄, the fifth link l₄₋₅, the sixth link l₄₋₇, the ninth link l₅₋₉ and the sixteenth link l₉₋₁₆ have disappeared.

This shows that the third link l₃₋₄, the fifth link l₄₋₅, the sixth link l₄₋₇, the ninth link l₅₋₉ and the sixteenth link l₉₋₁₆ each correspond to values of estimated covariance between the relevant apices which are strictly greater than the first thresholding value λ₁ but also strictly less than the second thresholding value λ₂. On the contrary, the first link l₁₋₅, the second link l₂₋₅, the fourth link l₃₋₇, the seventh link l₄₋₅, the eighth link l₅₋₅, the tenth link l₆₋₇, the eleventh link l₇₋₈, the twelfth link l₇₋₁₂, the thirteenth link l₅₋₉, the fourteenth link l₈₋₁₂ and the fifteenth link l₉₋₁₀ each correspond to the values of estimated covariance between the relevant apices which are strictly greater than the second thresholding value λ₂.

FIG. 5 illustrates a third graph G_{λ3} associated with a third thresholding value λ₃. As FIG. 5 is similar to FIG. 4, only the differences with FIG. 5 are detailed in the following.

The third thresholding value λ₃ is greater than the second thresholding value λ₂. Further, the third graph G_{λ3} does not include more than seven links since the first link l₁₋₅, the fourth link l₃₋₇, the tenth link l₆₋₇ and the fourteenth link l₈₋₁₂ have disappeared.

This shows that the first link l₁₋₅, the fourth link l₃₋₇, the tenth link l₆₋₇ and the fourteenth link l₈₋₁₂ each correspond to values of covariance estimated between the relevant apices which are strictly greater than the second thresholding value λ₂ but also strictly less than the third thresholding value λ₃. On the contrary, the second link l₂₋₅, the seventh link l₄₋₅, the eighth link l₅₋₅, the eleventh link l₇₋₅, the twelfth link l₇₋₁₂, the thirteenth link l₅₋₉, and the fifteenth link l₉₋₁₀ each correspond to values of covariance estimated among the relevant apices which are strictly greater than the third thresholding value λ₃.

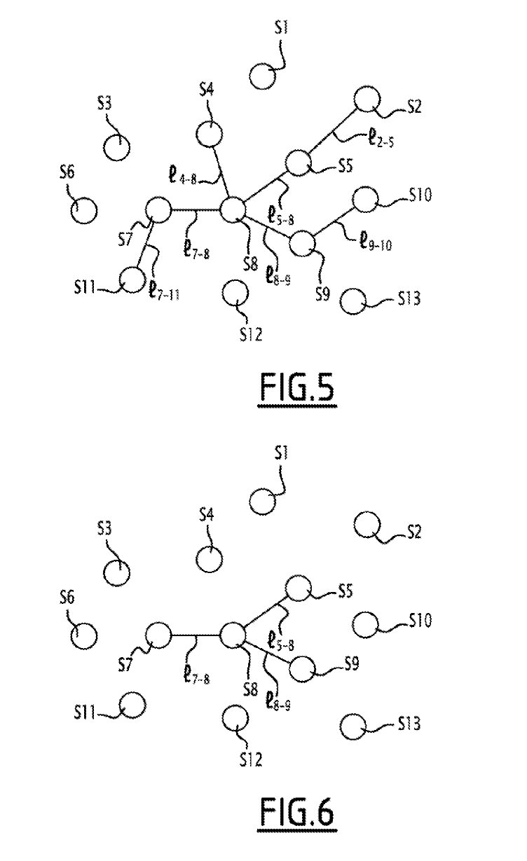

FIG. 6 illustrates a fourth graph G_{λ4} associated with a fourth thresholding value λ₄. As FIG. 6 is similar to FIG. 5, only the differences with FIG. 5 will be detailed in the following.

The fourth thresholding value λ₄ is greater than the third thresholding value λ₃. Further, the fourth graph G_{λ4} does not include more than three links since the second link l₂₋₅, the seventh link l₄₋₅, the twelfth link l₇₋₁₂ and the fifteenth link l₉₋₁₀ have disappeared.

This shows that the second link l₂₋₅, the seventh link l₄₋₈, the twelfth link l₇₋₁₂ and the fifteenth link l₈₋₁₈ each correspond to the values of estimated covariance among the relevant apices which are strictly greater than the third thresholding value λ₃ but also strictly less than the fourth thresholding value λ₄. On the contrary, the eighth link l₅₋₈, the eleventh link l₇₋₈, and the thirteenth link l₈₋₉ each correspond to the values of estimated covariance among the relevant apices which are strictly greater than the fourth thresholding value λ₄.

FIGS. 3 to 6 illustrate that the function which associates with the thresholding value λ the number of links to be generated in the graph G_{λ} associated with the thresholding value λ is a decreasing function. Indeed, with the first thresholding value λ₁, is associated the value of sixteen; with the second thresholding value λ₂, is associated the value of eleven; with the third thresholding value λ₃, is associated the value of seven and with the fourth thresholding value λ₄ is associated with the value of four.

According to another embodiment, the links on the graph are weighted with the intensity of the correlations. The weighting matrix or matrix of the weights of the links is the matrix grouping the absolute values of the matrix obtained at the end of the application of the estimation step 54.

The method for identifying a relationship comprises a step 58 for obtaining cores.

By definition, a core is a set of apices of a graph verifying three properties: the first property P1, the second property P2 and the third property P3.

According to the first property P1, the number of apices of the core is greater than or equal to a fixed number α.

Preferably, the fixed number α is greater than or equal to 3, preferentially greater than or equal to 5.

Preferably the fixed number α is greater than or equal to 15, preferentially greater than or equal to 10.

According to the second property P2, there exists a thresholding value λ for which the core is a connected component of the graph G_{λ} associated with the thresholding value λ.

In graph theory, a non-oriented graph is said to be connected if regardless of the relevant apices, there exists a sequence of links from the first apex to the second apex. A maximum connected sub-graph of any non-oriented graph is a connected component of this graph.

According to the third property P3, no other connected components of a graph exist for which the size is greater than or equal to the fixed number and which is included in the core.

In another wording, the existence of connected components having less apices than the fixed number is allowed and included in the core. It is also allowed that connected components having more or as many apices as the fixed number exist but each of these connected components has either to be included in the core or not share any apex with the core. Such a property P3 should be verified for all the thresholding values λ.

According to another way for presenting such a notion, a class core is a set of apices, of a set minimum size, which may all be connected through reliable paths involving weighted links (covariance) which are sufficiently significant. These paths, which form the link between the apices of a core, are stable on the graphs when the thresholding parameter is increased and this up to a quite high level. The apices not belonging to a core are on the contrary more rapidly isolated (no link with the other apices) on the graph gradually as the thresholding parameter is increased.

The step 58 for obtaining cores is applied by analyzing the time-dependent change in the graphs according to the variation of the thresholding value.

For this, a plurality of thresholding values is used. According to the example proposed with reference to FIGS. 3 to 6, four thresholding values λ₁, λ₂, λ₃ and λ₄ are proposed. The comparison of FIGS. 3 to 6 gives the possibility of showing that the core comprises in this case the four following apices: the fifth apex S5, the seventh apex S7, the eighth apex S8 and the ninth apex S9.

Preferably, the first plurality of thresholding values is used in an increasing way, i.e. by first considering the smallest value, and then the smallest value of the remaining values until consideration of the largest value.

Preferentially, the step 58 for obtaining cores is applied with an in-depth course algorithm.

For example, the minimum number of apices a of a core is set, a minimum thresholding value λₘᵢₙ and a parameter P are set for incrementing the thresholding value.

One begins by extracting the N connected components of the graph G_{λmin} for which the number of apices is greater than the fixed number α. N is an integer. The extraction of the connected components is obtained by applying an in-depth course algorithm.

As long as the integer N is different from 0, the following steps are repeated:
1) Increment the thresholding value of the preceding iteration by adding the parameter P in order to obtain a computational threshold value λ_{computed},
2) extracting the N connected components of the graph G_{λcomputed} for which the number of apices is greater than the fixed number α.
3) defining the cores, a core being a connected component of the graph G_{λcomputed-pitch} (the graph associated with the thresholding value of the preceding iteration which is, by definition of the thresholding value for computation λ_{computed}, the difference between the thresholding value of the computation λ_{computed} and parameter P) the intersection of which with each of the connected components extracted in the extraction step 2 is zero.

The whole of the threshold values used forms a plurality of thresholding values.

The method for identifying a relationship includes a step 60 for defining candidate graphs.

Each candidate graph is a graph associated with one of the thresholding values from the plurality of thresholding values.

According to the proposed example, the candidate graphs are the first graph G_{λ1}, the second graph G_{λ2}, the third graph G_{λ3} and the fourth graph G_{λ4}.

The method for identifying a relationship also includes a step 62 for obtaining the distributions associated with each thresholding value from the plurality of thresholding values.

By the term of distribution associated with a thresholding value λ is meant a partitioning into one or several classes of the apices of the graph G_{λ} associated with the relevant thresholding value λ. A class is a set of apices. In the following, such a distribution is noted as R_{λ}.

Depending on the relevant example, four distributions R_{λ1}, R_{λ2}, R_{λ3} and R_{λ4} are therefore to be obtained.

Preferably, in step 62 for obtaining the distributions, the plurality of thresholding values is used in a decreasing way, i.e. by first considering the largest value, and then the largest value of the remaining values until the smallest value is considered.

Each of the distributions are obtained by a distinct optimization operation.

The optimization starts from an initial distribution in which with each core is associated a class for obtaining a final distribution in which each apex of a class shares more links with the other apices of the same class than with the apices of another class.

Many ways for implementing the optimization exist. Notably, two ways are more specifically described in the following description, being aware that other ways are accessible to one skilled in the art.

According to a first method, for a given thresholding parameter λ, the graph G_{λ} is partitioned in order to obtain a distribution in which each class comprises a single core and minimizing the cost or weight of the section, defined by the sum of the weights of the links between the classes. By definition, the sum of the weights of the links between the classes is defined by the sum of the absolute value of the links existing between an apex of a class and an apex of the other one. The set of apices and cores taken into account for the distribution depends on the thresholding parameter. We are not interested in the isolated apices and the connected components of too small sizes. We note as V*(λ), the set of the apices contained in connected components of the graph G_{λ} for which the number of apices is greater than equal to the fixed number α. Such connected components comprise at least one core.

For a fixed thresholding value λ, if V*(λ) contains K cores (K being a positive integer), Q₁, . . . , Q_{K}, a partition of V*(λ) into K classes, C₁, . . . , C_{K}, is sought, such that each class Qₖ is the union of a core Qₖ and of a set of apices Sₖ at the periphery of this core (which may be empty): Cₖ=Qₖ∪Sₖ.

If the set V*(λ) is empty, i.e. V*(λ)=ø, all the apices of V are isolated or contained in connected components of a too small size (strictly less than the fixed number α) and the question of the partitioning of the graph is not posed.

If the set V*(λ) contains a single core, the partitioning of the graph is trivial, a single class groups all the apices of V*(λ).

When the set V*(λ) contains several cores, the apices Sₖ around these cores are selected so as to have a minimum weight section. The weight matrix of the links of the graph G_{λ} is noted as W(λ) and S refers to the whole of the portions of A=V*(λ)\{Q₁, . . . , Q_{K}}. S₁, . . . , S_{K} are the solution to the following optimization problem:

$$arg {min}_{{S}_{1} , … {S}_{K}} \{ {\sum }_{k = 1}^{K} {\sum }_{i ∈ {C}_{k} , j ∈ {C}_{k}} {w}_{ij} ; {S}_{k} ∈ S et {C}_{k} = {S}_{K} {UQ}_{k} , ∀ k = 1 … K \}$$

The first partitioning method described earlier guarantees the fact that an apex which is not in a core is more strongly connected with the class which is assigned to it, than with any other class (by assuming that there cannot be any equality).

According to a second more elaborated method, the optimization comprises a step for determining the cores for which one apex shares more links with the apices of another class than with the apices of its class. In such a case, the determined cores are no longer considered as cores but as a set of isolated apices which may each belong to a different class. This gives the possibility of avoiding classification errors.

In another wording, as it is supposed that the core of the class is the most stable and the most central portion of the class (the furthest away from the other classes), if a core contains at least one apex better connected to another class, the core is “declassified” by considering the apices of this core as being simples peripheral apices and we carry out new partitioning of the graph.

From a mathematical point of view, it is possible to implement the second method by coming back to the formulation of the first method. Indeed, if in a core Q it is possible to find an apex q, less strongly connected with its class Cᵢ, than with another class Cₚ, a partition of V*(λ) into K−1 classes is sought by no longer considering Qᵢ as a core (A=A∪Q₁) in the optimization problem posed within the scope of the first method. This is repeated until the whole of the apices are more strongly connected to the class which is assigned to them than any other class.

According to the example of FIG. 2, the steps 60 for defining candidate graphs and the step 62 for obtaining the distributions are simultaneously applied for accelerating the application of the method for identifying a relationship. This is indicated in FIG. 2 by the fact that both definition 60 and obtaining 62 steps are at the same level.

The method for identifying a relationship also includes a step 64 for selecting an optimum graph from among the plurality of candidate graphs according to at least one criterion.

The criteria(on) selected give the possibility of selecting a candidate graph corresponding to a good compromise in terms of density. Indeed, the denser a candidate graph and the more the relevant candidate graph takes into account the information. On the contrary, the less dense the candidate graph and the more the relevant candidate graph shows sets of clearly identifiable apices.

Preferably, in the selection step 64, at least two criteria are used, the first criterion dealing with the graph and the second criterion being relative to the distribution associated with the graph.

For this, according to an example of a first criterion, the selected candidate graph is the graph for which the difference between the distribution of the connectivity degrees and a distribution according to a power law is a minimum.

The connectivity degree of an apex is for example computed by forming the sum of the weights associated with the links of the relevant apex.

The distribution according to a power law is, according to a particular example, a Pareto law.

The distribution according to a power law is, according to another particular example, a scale-invariant network law.

The difference is, as an illustration, a Euclidean distance.

According to an example, the second criterion is modularity. The modularity is a criterion comparing the proportion of links of a class of a graph with the proportion obtained for links randomly placed on the relevant graph. The distributions for which the modularity is large will be promoted.

According to another example, the second criterion is the number of classes. The distributions for which the number of classes is maximum will be promoted.

According to another example, the second criterion is the stability of the number of classes with the variation of the thresholding value λ. The distributions for which the number of classes is the most stable will be promoted.

The method for identifying a relationship therefore gives the possibility of obtaining an optimum graph and an optimum distribution of the physical elements. Belonging to a same class indicates that there exists a relationship between the studied physical elements.

In order to obtain such a piece of information, the identification method allows better determination of the graph and of the distribution than the methods of the state of the art in so far that such methods do not carry out optimization on the graph during the partitioning into classes of the graph.

The method for identifying a relationship therefore allows identification of sets of physical elements having a relationship between them on the basis of the relevant representative quantity.

In particular, the method for identifying a relationship may give the possibility of identifying sets of genes having a relationship between them on the basis of their expression levels in the relevant samples, or having similar expression profiles. Genes for which the expression profiles are similar (co-expressed genes) may for example have identical regulation mechanisms or be part of a same regulation route, i.e. be co-regulated.

The regulation of the expression of a gene refers to the whole of the regulation mechanisms applied during the process for synthesizing a product of a functional gene (RNA or protein) from the genetic piece of information contained in a DNA sequence. The regulation refers to modulation, in particular an increase or a reduction in the amount of products of the expression of a gene (RNA or protein). All the steps ranging from the DNA sequence to the final product of the expression of a gene may be regulated, whether this be the transcription, the ripening of the messenger RNAs, the translation of the messenger RNAs or the stability of the messenger RNAs or of the proteins.

For example, the method for identifying a relationship may give the possibility of identifying a relationship between genes or proteins which are all strongly expressed, or strongly over-expressed relatively to a control, or between genes or proteins which are all not very expressed, or strongly under-expressed relatively to a control.

In a preferred embodiment, the method for identifying a relationship advantageously gives the possibility of organizing the genes, the RNAs or the proteins, for which the expression profiles are identical, into groups or sets, according to a hierarchical grouping.

According to a particular embodiment, the method for identifying a relationship advantageously gives the possibility of identifying interactions between genes.

According to another embodiment, the method for identifying a relationship advantageously gives the possibility of identifying sets of genes which are co-expressed and/or co-regulated. This may give the possibility of identifying regulation routes which are not yet known. Moreover, a gene, the function of which is unknown and which is part of a set containing a large number of genes involved in a particular cell function or a particular cell process, has a strong probability of being itself also involved in this function or in this process. Thus, starting from the assumption that co-expressed and/or co-regulated genes may be functionally related, the method may give the possibility of identifying the putative function of certain genes.

According to a preferred embodiment, the method for identifying a relationship also includes a step in which the classes obtained in the optimum distribution are ordered.

For this, each class of the optimum distribution is associated on a one-to-one basis with a value of the representative quantity. Therefore, such a value is a synthetic value which summarizes the relevant class.

Such an association is obtained by different methods.

For example, the most significant variable in the class is selected according to a criterion, such a criterion may be the centrality or the connectivity degree to the other apices.

According to another example, the use of a method for reducing the dimensionality of the class in order to infer therefrom a synthetic value is proposed. The analysis in main components is an example of such a method for reducing the dimensionality of the class.

Again according to another example, the synthetic value is a function of the representative quantities of each variable of the class.

For example, each class of the optimum distribution is associated with the average value of the whole of the representative quantities of the apices which the relevant class includes. The average value is for example an arithmetic mean value, a geometrical mean value or a mean value weighted by coefficients related to the intensity of the correlations between the relevant apices. Preferably, the function is a linear function.

According to another embodiment, it is also possible to apply regression in order to model the representative quantity from classes of variables themselves and for selecting the classes or the most significant variables in the model.

This gives the possibility of facilitating the utilization of the optimal distribution and of the optimum graph obtained at the end of the application of the method for identifying a relationship.

Further, this also makes possible the method for identifying a relationship, which may be utilized for applying other methods illustrated in reference to the flowcharts of FIGS. 7, 8 and 9.

Such methods may also be applied by means of the system 10 proposed in FIG. 1 provided that the program instructions of the computer program product are adapted so that, when the computer program is applied on the data processing unit, the computer program causes application of the relevant method.

From among the proposed methods, with reference to FIG. 7, a method for identifying a therapeutic target for preventing and/or treating a pathology is considered. Such a method for identifying a therapeutic target utilizes the fact that the method for identifying a relationship notably gives the possibility of identifying, from among several thousands of genes, of RNAs or of proteins for example, those which are expressed in a differential way between a healthy tissue and a diseased tissue and therefore involve in the development of a disease.

By therapeutical target of a pathology, is meant any biological elements on which it is possible to act for preventing and/or treating this pathology. The therapeutic target may in particular be a gene or a product of the expression of a gene. For example, the product of the expression of a gene is an RNA, in particular a messenger RNA or a protein.

The method for identifying a therapeutic target includes a first step 100 for applying the method for identifying a relationship as described earlier for the cases when the physical elements are genes, the plurality of individuals is a plurality of biological individuals suffering from the pathology and the representative quantity is the quantification of the expression of at least one gene of the plurality of individuals. Such a first step 100 for applying the method for identifying a relationship notably gives the possibility of obtaining an optimum distribution, a so called first distribution R1, including first classes C1ᵢ, i being an integer varying between 1 and the number of classes of the first distribution R1, in which are distributed the apices representative of the genes.

The first step 100 for applying the method for identifying a target includes a sub-step in which the first classes C1ᵢ obtained in the first distribution R1 are ordered, in order to obtain a first distribution R1 in which each first class C1ᵢ is associated on a one-to-one basis to a first value Z1ᵢ of the representative quantity.

The method for identifying a therapeutic target also includes a second step 110 for applying the method for identifying a relationship as described earlier for the case when the physical elements are genes, the plurality of individuals is a plurality of biological individuals not suffering from the pathology and the representative quantity is the quantification of the expression of at least one gene of the plurality of individuals. Such a second step 110 for applying the method for identifying a relationship notably gives the possibility of obtaining an optimum distribution, a so called second distribution R2, including second classes C2ⱼ, j being an integer varying between 1 and the number of classes of the second distribution R2, in which are distributed the representative apices of the genes.

The second step 110 for applying the method for identifying a target includes a sub-step in which the second classes C2ⱼ obtained in the second distribution R2 are ordered, in order to obtain a second distribution R2 in which each second class C2ⱼ is associated on a one-to-one basis with a second value Z2ⱼ of the representative quantity.

Preferably, the first and second steps 100 and 110 for applying the method for identifying a relationship are applied simultaneously for reducing the time for applying the method for identifying a therapeutic target. This is indicated in FIG. 7 by the fact that both steps 100 and 110 for applying the method for identifying a relationship are found at the same level.

The method for identifying a therapeutic target also includes a step 120 for comparing the first distribution R1 and the second distribution R2.

The method for identifying a therapeutic target also includes a step 130 for selecting as a therapeutic target, a gene or a product of the expression of the gene. The gene or the product of the expression of the gene is selected when a condition is verified. The representative apex of the gene in the first distribution R1 belongs to a first class C1ᵢ₀ wherein i0 refers to the number of the class. Said first class C1ᵢ₀ is associated with a first value Z1ᵢ₀. The representative apex of the gene in the second distribution R1 belongs to a second class C2ⱼ₀ wherein j0 refers to the number of the class. Said second class C2ⱼ₀ is associated with a second value Z2ⱼ₀. The condition for selecting the gene or the product of the expression of the gene is verified when the first value Z1ᵢ₀ significantly differs from the second value Z2ⱼ₀.

By the expression <<significantly different>> is meant that the second value Z2ⱼ₀ differs from the first value Z1ᵢ₀ by more than 1% of the first value Z1ᵢ₀, preferably more than 5% of the first value Z1ᵢ₀ and preferentially more than 10% of the first value Z1ᵢ₀.

The method for identifying a therapeutic target may notably give the possibility of determining a target efficiently.

From among the proposed methods, with reference to FIG. 8, a method for identifying a diagnostic biomarker, a susceptibility, prognostic biomarker of a pathology or predictive of a response to a treatment of a pathology is also considered. The biomarker may in particular be a gene or a product of the expression of a gene. For example, the product of the expression of a gene is an RNA, in particular a messenger RNA or a protein.

The method for identifying a biomarker includes a first step 200 for applying the method for identifying a relationship as described earlier for the case when the physical elements are genes, the plurality of individuals is a plurality of biological individuals suffering from the pathology and the representative quantity is the quantification of the expression of at least one gene of the plurality of individuals. Such a first step 200 for applying the method for identifying a relationship notably gives the possibility of obtaining an optimum distribution, a so called first distribution R1, including first classes C1ᵢ, i being an integer varying between 1 and the number of classes of the first distribution R1, in which are distributed the representative apices of the genes.

The first step 200 for applying the method for identifying a biomarker includes a sub-step in which the first classes C1ᵢ obtained in the first distribution R1 are ordered, in order to obtain a first distribution R1 in which each first class C1ᵢ is associated in a one-to-one basis with a first value Z1ᵢ of the representative quantity.

The method for identifying a biomarker also includes a second step 210 for applying the method for identifying a relationship as described earlier for the case when the physical elements are genes, the plurality of individuals is a plurality of biological individuals not suffering from the pathology and the representative quantity is the quantification of the expression of at least one gene of the plurality of individuals. Such a second step 210 for applying the method for identifying a relationship notably gives the possibility of obtaining an optimum distribution, a so called second distribution R2, including second classes C2ⱼ, j being an integer varying between 1 and the number of classes of the second distribution R2, in which are distributed the representative apices of the genes.

The second step 210 for applying the method for identifying a relationship includes a sub-step in which the second classes C2ⱼ obtained in the second distribution R2 are ordered, in order to obtain a second distribution R2 in which each second class C2ⱼ is associated on a one-to-one basis to a second value Z2ⱼ of the representative quantity.

Preferably, the first and second steps 200 and 210 for applying the method for identifying a relationship are applied simultaneously in order to reduce the time for applying the method for identifying a biomarker. This is indicated in FIG. 8 by the fact that both steps 200 and 210 for applying the method for identifying a relationship are found at the same level.

The method for identification a biomarker also includes a step 220 for comparing the first distribution R1 and the second distribution R2.

The method for identifying a biomarker also includes a step 230 for selecting as a biomarker a gene or a product of the expression of the gene. The gene or the product of the expression of the gene is selected when a condition is verified. The representative apex of the gene in the first distribution R1 belongs to a first class C1ᵢ₀ wherein i0 refers to the number of the class. Said first class C1ᵢ₀ is associated with a first value Z1ᵢ₀. The representative apex of the gene in the second distribution R1 belongs to a second class C2ⱼ₀ wherein j0 refers to the number of the class. Said second class C2ⱼ₀ is associated with a second value Z2ⱼ₀. The condition for selecting the gene or the product of the expression of the gene is verified when the first value Z1ᵢ₀ significantly differs from the second value Z2ⱼ₀.

By the expression <<significantly different>> is meant that the second value Z2ⱼ₀ differs from the first value Z1ᵢ₀ by more than 1% of the first value Z1ᵢ₀, preferably by more than 5% of the first value Z1ᵢ₀ and preferentially more than 10% of the first value Z1ᵢ₀.

The method for identifying a biomarker notably gives the possibility of determining a biomarker efficiently.

From among the proposed methods, with reference to FIG. 9, a method for screening a compound, useful as a drug, is also considered, having an effect on a known therapeutic target, for preventing and/or treating a pathology. Such a method for screening a compound utilizes the fact that the method for identifying a relationship gives the possibility of identifying, from among several thousands of genes, of RNAs, or proteins for example, those which are expressed in a differential way in the presence or in the absence of a compound intended to treat a disease.

The method for identifying the screening includes a first step 300 for applying the method for identifying a relationship as described earlier for the case when the plurality of individuals is a plurality of biological individuals suffering from the pathology and having received the compound, the representative quantity is the quantification on the expression of at least one gene of the plurality of individuals and the data comprising the representative quantity of the known therapeutic target. Depending on the cases, the therapeutic target may be a gene or a product of the expression of a gene. When the therapeutic target is a gene, the physical elements are genes. When the therapeutic target is the product of the expression of a gene, the physical elements are the same product of the expression of a gene. As an example, when the therapeutic target is an RNA, the physical elements are RNAs. According to another example, when the therapeutic target is a protein, the physical elements are proteins.

Such a first step 300 for applying the method for identifying a relationship notably gives the possibility of obtaining an optimum distribution, a so called first distribution R1, including first classes C1ᵢ, i being an integer varying between 1 and the number of classes of the first distribution R1, in which are distributed the representative apices of the genes.

The first step 300 for applying the method for identifying a relationship includes a sub-step in which the first classes C1ᵢ obtained in the first distribution R1 are ordered, in order to obtain a first distribution R1 in which each first class C1ᵢ is associated on a one-to-one basis with a first value Z1ᵢ of the representative quantity.

The screening method also includes a second step 310 for applying the method for identifying a relationship as described earlier for the case when the plurality of individuals is a plurality of biological individuals suffering from said pathology and not having received said compound, the representative quantity is the quantification of the expression of at least one gene of the plurality of individuals and the data comprise the representative quantity of the known therapeutic target. Depending on the cases, the therapeutic target may be a gene or a product of the expression of a gene. When the therapeutic target is a gene, the physical elements are genes. When the therapeutic target is the product of the expression of a gene, the physical elements are the same product of the expression of a gene. As an example, when the therapeutic target is an RNA, the physical elements are RNAs. According to another example, when the therapeutic target is a protein, the physical elements are proteins.

Such a second step 310 for applying the method for identifying a relationship notably gives the possibility of obtaining an optimum distribution, a so called second distribution R2, including second classes C2ⱼ, j being an integer varying between 1 and the number of classes of the second distribution R2, in which are distributed the representative apices of the genes.

The second step 310 for applying the method for identifying a relationship includes a sub-step in which the second classes C2ⱼ obtained in the second distribution R2 are ordered, in order to obtain a second distribution R2 in which each second class C2ⱼ is associated on a one-to-one basis with a second value Z2ⱼ of the representative quantity.

Preferably, the first and second steps 300 and 310 for applying the method for identifying a relationship are applied simultaneously for reducing the time for applying the screening method. This is indicated in FIG. 9 by the fact that both steps 300 and 310 for applying the method for identifying a relationship are found at the same level.

The screening method also includes a step 320 for comparing the first distribution R1 and the second distribution R2.

The screening method also includes a step 230 for selecting a compound which may be used as a drug. The compound is selected when a condition is verified. The representative apex of the known therapeutic target in the first distribution R1 belongs to a first class C1ᵢ₀ wherein i0 refers to the number of the class. Said first class C1ᵢ₀ is associated with a first value Z1ᵢ₀. The representative apex of the known therapeutic target in the second distribution R1 belongs to a second class C2ⱼ₀ wherein j0 refers to the number of the class. Said second class C2ⱼ₀ is associated with a second value Z2ⱼ₀. The condition for selecting the compound is verified when the first value Z1ᵢ₀ significantly differs from the second value Z2ⱼ₀.

By the expression <<significantly differ>> is meant that the second value Z2ⱼ₀ differs from the first value Z1ᵢ₀ by more than 1% of the first value Z1ᵢ₀, preferably by more than 5% of the first value Z1ᵢ₀ and preferentially by more than 10% of the first value Z1ᵢ₀.

The screening method notably gives the possibility of efficiently screening a compound which may be used as a drug.

Each of the methods proposed may be applied by means of any computer or any other type of device. Multiple systems may be used with programs applying the previous methods but it may also be contemplated to use apparatuses dedicated to the application of the previous methods, the latter being able to be inserted into the devices specific for measuring the provided data. Further, the proposed embodiments are not connected to a particular programming language. Incidentally, this implies that many programming languages may be used for applying one of the methods detailed earlier.

The methods and embodiments described above are able to be combined with each other, either totally or partly, in order to give rise to other embodiments of the invention.

1. A method for identifying a relationship between biological elements, said biological elements optionally having a measurable activity, the method being applied by a computer and comprising the following steps:
providing data from biological samples of a plurality of biological individuals, the data comprising a representative quantity of the biological elements or of their activity for the plurality of biological individuals,
estimating the covariance matrix between the different representative quantities of the biological elements or of their activity from provided data,
associating a graph with a thresholding value, the associated graph comprising representative apices of the biological elements and links between the apices when the value of the covariance between the relevant apices is greater than the relevant thresholding value,
obtaining cores by analyzing the time-dependent change of the graphs by using a plurality of thresholding values, a core being a set of apices of a graph such that the number of apices is greater than or equal to a set number, such that a thresholding value exists for which the core is a connected component of the graph associated with the thresholding value and such that no other connected components exist of a graph for which the number of apices is greater than or equal to the set number and which is included in the core,
defining candidate graphs, each candidate graph being a graph associated with one of the thresholding values of the plurality of thresholding values,
for each thresholding value of the plurality of threshold values, obtaining a distribution associated by optimization by the distribution into classes of the apices of the graph associated with the relevant thresholding value, the optimization starting from an initial distribution in which with each core is associated a class for obtaining a final distribution in which each apex of a class shares more links with the other apices of the same class than with the apices of another class,
selecting an optimum graph from among the plurality of candidate graphs according to at least one criterion.

2. The method according to claim 1, wherein in the step for obtaining the cores, the values of the plurality of the thresholding values are used in an increasing way.

3. The method according to claim 1 wherein in the step for obtaining an associated distribution, the values of the plurality of thresholding values are used in a decreasing way.

4. The method according to claim 1 wherein the step for estimating the covariance matrix includes a sub-step for computing the empirical covariance matrix, a regularization sub-step and a normalization sub-step.

5. The method according to claim 1 wherein the step for obtaining cores applies an in-depth course algorithm.

6. The method according to claim 1 wherein the final distribution includes less classes than the number of obtained cores.

7. The method for identifying a relationship according to claim 1 wherein the number of biological elements is greater than or equal to 1000, preferentially greater than or equal to 3000, still more preferentially greater than or equal to 5000.

8. The method for identifying a relationship according to claim 1 wherein the ratio between the number of biological elements and the number of biological individuals is greater than or equal to 10, preferentially greater than or equal to 30, still more preferentially greater than or equal to 50.

9. The method for identifying a relationship according to claim 1 wherein the biological elements are genes, RNAs, proteins or metabolites.

10. The method for identifying a relationship according to claim 1 wherein the biological individuals are animals, preferentially mammals, still more preferentially humans.

11. The method according to claim 1, further comprising identifying a therapeutic target for preventing and/or treating a pathology using the following steps:
applying the method for identifying a relationship according to claim 1 wherein the plurality of individuals is a plurality of biological individuals suffering from said pathology and the representative quantity is the quantification of the expression of at least one gene of the plurality of individuals, in order to obtain a first distribution in which each first class is associated on a one-to-one basis with a first value of the representative quantity,
applying the method for identifying a relationship according to claim 1 wherein the plurality of individuals is a plurality of biological individuals not suffering from said pathology and the representative quantity is the quantification of the expression of at least one gene of the plurality of individuals, in order to obtain a second distribution in which each second class is associated on a one-to-one basis with a second value of the representative quantity,
comparing the first distribution and the second distribution, and
selecting as a therapeutic target the gene, or a product of the expression of the gene, if the representative apices of said gene belongs to a first class and to a second class for which the first value and the second value significantly differ.

12. The method according to claim 1, further comprising identifying a diagnostic, susceptibility, prognostic biomarker of a pathology or predictive of a response to a treatment of a pathology using the following steps:
applying the method for identifying a relationship according to claim 1 wherein the plurality of individuals is a plurality of biological individuals suffering from said pathology and the representative quantity is the quantification of the expression of at least one gene of the plurality of individuals, in order to obtain a first distribution in which each first class is associated on a one-to-one basis with a first value of the representative quantity,
applying the method according to claim 1 wherein the plurality of individuals is a plurality of biological individuals not suffering from said pathology and the representative quantity is the quantification of the expression of at least one gene of the plurality of individuals, in order to obtain a second distribution in which each second class is associated on a one-to-one basis with a second value of the representative quantity,
comparing the first distribution and the second distribution, and
selecting as a biomarker the gene, or an expression of the gene, if the representative apices of said gene belong to a first class and to a second class, for which the first value and the second value differ significantly.

13. The method according to claim 1, further comprising screening a compound, useful as a drug, having an effect on a known therapeutic target, for preventing and/or treating a pathology using the following steps:
applying the method for identifying a relationship according to claim 1 wherein the plurality of individuals is a plurality of biological individuals suffering from said pathology and having received said compound, the representative quantity is the quantification of the expression of at least one gene of the plurality of individuals, and the data comprising the representative quantity of the therapeutic target, in order to obtain a first distribution in which each first class is associated on a one-to-one basis with a first value of the representative quantity,
applying the method for identifying a relationship according to claim 1 wherein the plurality of individuals is a plurality of biological individuals suffering from said pathology and not having received said compound, the representative quantity is the quantification of the expression of at least one gene of the plurality of individuals, and the data comprising the representative quantity of the therapeutic target, in order to obtain a second distribution in which each second class is associated on a one-to-one basis with a second value of the representative quantity,
comparing the first distribution and the second distribution, and
selecting the compound if the representative apices of the known therapeutic target belong to a first class and to a second class for which the first value and the second value differ significantly.

14. (canceled)

15. A non-transitory computer-usable storage medium having computer readable instructions stored thereon for execution by a processor to perform a method according to claim 1.
